(19) United States
(12) Patent Application Publication
(10) Pub. No.: US 2016/0033048 A1
(43) Pub. Date: Feb. 4, 2016

(54) RAINWATER DIVERTER ASSEMBLY

(71) Applicant: PENN UNITED TECHNOLOGIES, INC., Cabot, PA (US)

(72) Inventor: Mark Noah, Butler, PA (US)

(73) Assignee: PENN UNITED TECHNOLOGIES, INC., Cabot, PA (US)

(21) Appl. No.: 14/811,898

(22) Filed: Jul. 29, 2015

Related U.S. Application Data
(60) Provisional application No. 62/031,408, filed on Jul. 31, 2014.

(51) Int. Cl. F16K 11/052; E04D 13/08

(52) U.S. Cl. CPC F16K 11/0525; E04D 13/08; E04D 2013/0813; E04D 2013/0853

(57) ABSTRACT

A diverter assembly for a downspout is provided. The diverter assembly includes a housing assembly and a deflector assembly. The housing assembly defines a generally vertical passage and includes an inlet port, a first outlet port and a second outlet port. The deflector assembly includes a movable deflector member. The deflector member is disposed in the housing assembly passage and moves between a first position, a dumping position, and a closed position.

### CROSS REFERENCE TO RELATED APPLICATION

This application is traditional patent application of and claims priority to U.S. Provisional Patent Application Ser. No. 62/031,408, filed Jul. 31, 2014 entitled, RAINWATER DIVERTER ASSEMBLY.

### BACKGROUND OF THE INVENTION

1. Field of the Invention

The disclosed and claimed concept relates to a downspout and, more specifically, to a diverter assembly disposed in a downspout.

2. Background Information

Gutters and downspouts for homes and other buildings are well known. A downspout includes an upper first end, that is in fluid communication with the gutter, and, lower, second end that acts as a drain. That is, the downspout second end allows fluid to exit the downspout. Generally, a downspout second end is disposed adjacent to the ground. The downspout second end may lead directly into a drain pipe, or, may simply allow fluid to spill onto the ground. Alternatively, a downspout second end may be disposed in a fluid container such as, but not limited to, a rain barrel. In this configuration, rainwater is collected in the fluid container.

Each configuration has disadvantages. In the first configuration, rainwater is simply lost. This is a disadvantage as collected rainwater is useful for watering lawns and gardens, or may be used to fill a pool or pond. Using rainwater allows the user to avoid using city water which must be paid for and which contains agents such as chlorine. In the second configuration, rainwater often transports debris, such as but not limited to leaves and sticks that have fallen on a roof. The debris is not desirable in a rain barrel or a pool.

Diverter assemblies for downspouts are known. One type of diverter assembly includes an inverted Y-shaped conduit with a movable planar deflector member disposed therein. The downspout is coupled to, and in fluid communication with, the single upper conduit. Two other downspouts are each coupled to, and in fluid communication with, the one of the lower conduits. The deflector member directs the fluid flow to one of the two lower conduits. Thus, for example, in the Spring, rainwater can be directed to one conduit that leads to a fluid container and in the Fall, when there is a greater likelihood of leaves and debris to be present, rainwater can be directed to a drain via the other conduit. The disadvantage to this system is that some debris is present in the Spring and rainwater is not collected in the Fall.

Other diverters include an inner conduit encircled by a reservoir with an outlet. The reservoir sidewall extends about both the downspout and the inner conduit. The inner conduit is sized to generally correspond to the downspout. The downspout merges with the upper end of the reservoir but there is a vertical gap between the upper end of the reservoir and the inner conduit. In this configuration, water tends to run along the surface of the downspout onto the upper end of the reservoir before passing through the gap into the reservoir. Debris tends to fall down the center of the downspout and into the inner conduit. Thus, much of the water is separated from the debris. The reservoir includes an outlet that is coupled to a hose. The hose leads to a rain barrel. Such diverter assemblies may include more complex filter systems and other elements thereby forming an intricate assembly having numerous parts all subject to wear and tear. Further, the reservoir collects small amounts of debris and, over a period of time, can become clogged.

In one embodiment, the rain barrel is sealed. Thus, when the rain barrel is full, water backs up the hose, fills the reservoir and eventually drains through the inner conduit. To accomplish this, the hose must use a substantially water tight coupling. A standard threaded hose coupling is not sufficiently watertight to maintain water in the closed system. That is, a standard threaded hose coupling tends to allow at least a small amount of leakage. Accordingly, such diverter assemblies use a barbed hose coupling and require the use of a specialized hose, i.e. hose that has a coupling other than a standard threaded coupling. Such hoses are more expensive than hoses with a standard threaded coupling. Further, such hoses are generally short so as to resist the formation of bubbles, e.g. from entrained gas, within the closed system and especially within the hose. Further, the diverter assembly must be positioned on the downspout in a narrow range of elevations close to and/or above the top rain barrel. In this configuration, the hose between the diverter and the rain barrel is maintained in a generally straight shape. This is a disadvantage as the user may wish for the rain barrel to be disposed at a location “spaced” from the downspout, e.g. wherein the rain barrel may be hidden from sight. Further, the user may not wish to place the diverter assembly at a high elevation on the downspout where it can be seen. The combination of a short hose and a limited position wherein the diverter assembly can be located on the downspout means that the rain barrel must be maintained fairly close to the downspout. This is a disadvantage as the user may be required to keep the rain barrel in an inconvenient or highly visible location,

Alternatively, the rain barrel may be open, i.e. not a closed system. In this configuration, and when the diverter is at a higher elevation than the top of the barrel, the rain barrel simply overflows when full. That is, the diverter always directs water to the rain barrel with no construct for redirecting the water when the rain barrel is full. This is a disadvantage as the flow of water is, essentially, uncontrolled. That is, this type of diverter assembly is not controllable in that the user cannot select where the water is directed.

There is, therefore, a need for a diverter assembly that separates debris from the water flow and which allows the user to select where the water flows. There is a further need for a diverter assembly with a reduced number of elements or parts.

### SUMMARY OF THE INVENTION

These needs, and others, are met by at least one embodiment of the disclosed and claimed concept which provides a diverter assembly for a downspout that includes a housing assembly and a deflector assembly. The housing assembly defines a generally vertical passage and includes an inlet port, a first outlet port and a second outlet port. The deflector assembly includes a movable deflector member. The deflector member is disposed in the housing assembly passage and moves between a first position, a dumping position, and a closed position.

A diverter assembly for a downspout in the configurations described herein solves the problems set forth above.

### BRIEF DESCRIPTION OF THE DRAWINGS

A full understanding of the invention can be gained from the following description of the preferred embodiments when read in conjunction with the accompanying drawings in which:

FIG. 1 is a schematic view of a diverter assembly on a downspout,

FIG. 2 is a view of a diverter assembly in a first position,

FIG. 3 is a view of a diverter assembly in a dumping position,

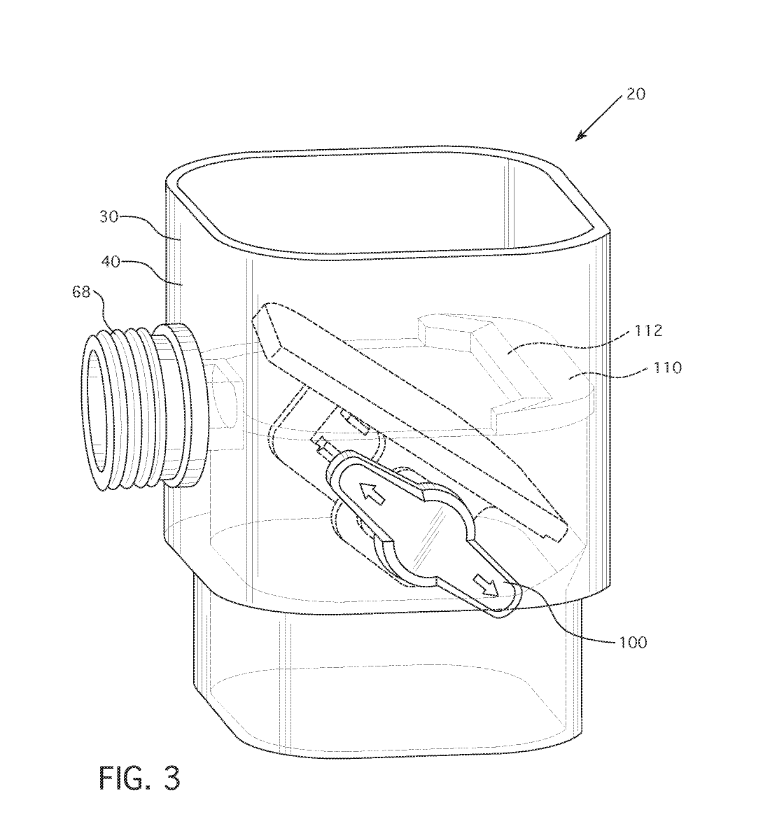

FIG. 4 is a cross-sectional view of a diverter assembly in a second position.

FIG. 5 is another cross-sectional view of a diverter assembly in a first position,

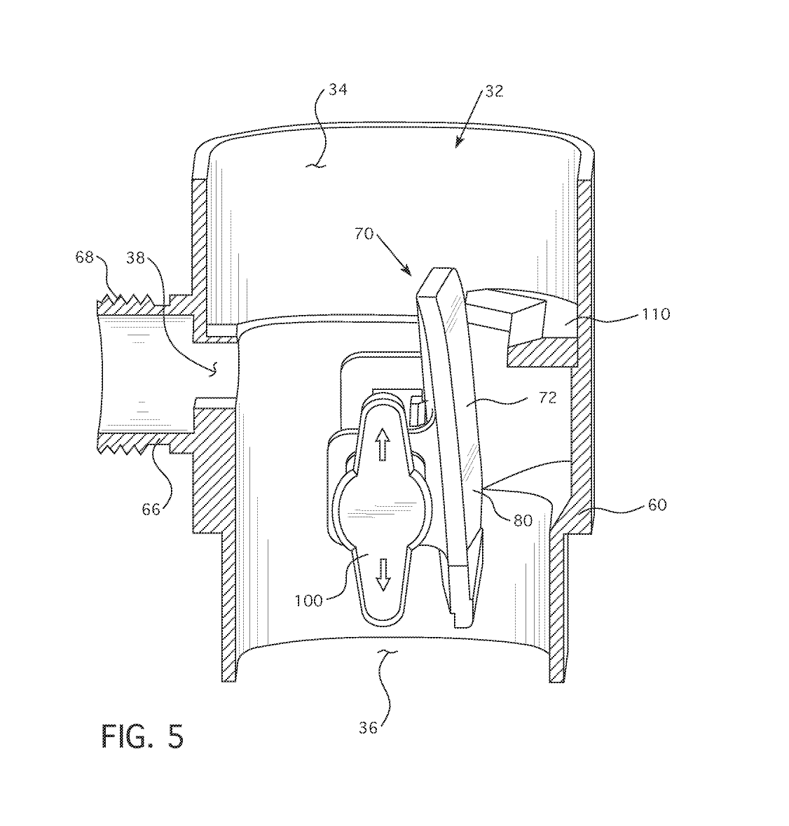

FIG. 6 is another cross-sectional view of a diverter assembly in a dumping position.

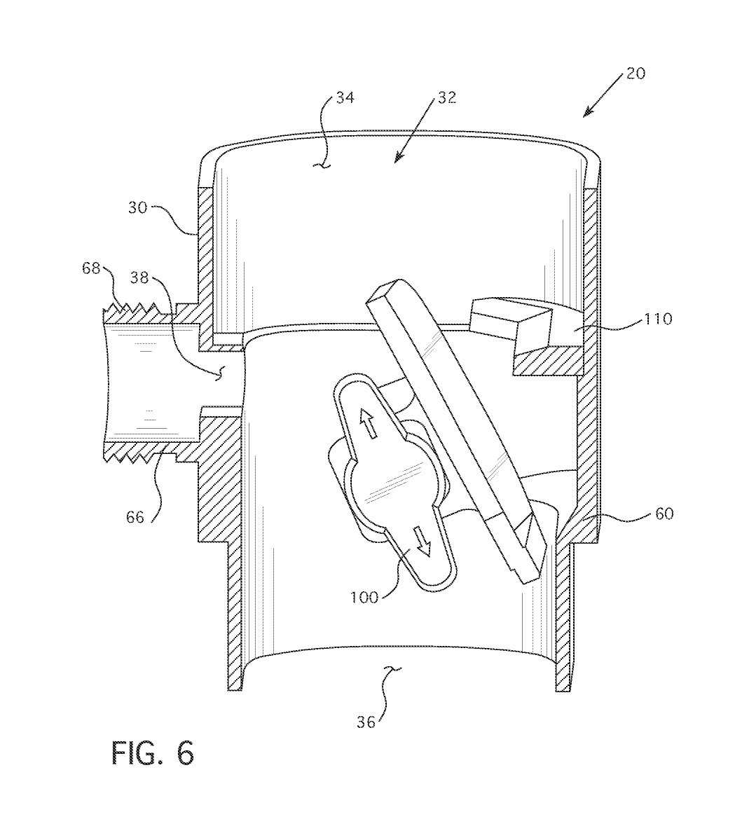

FIG. 7 is another cross-sectional view of a diverter assembly in a second position.

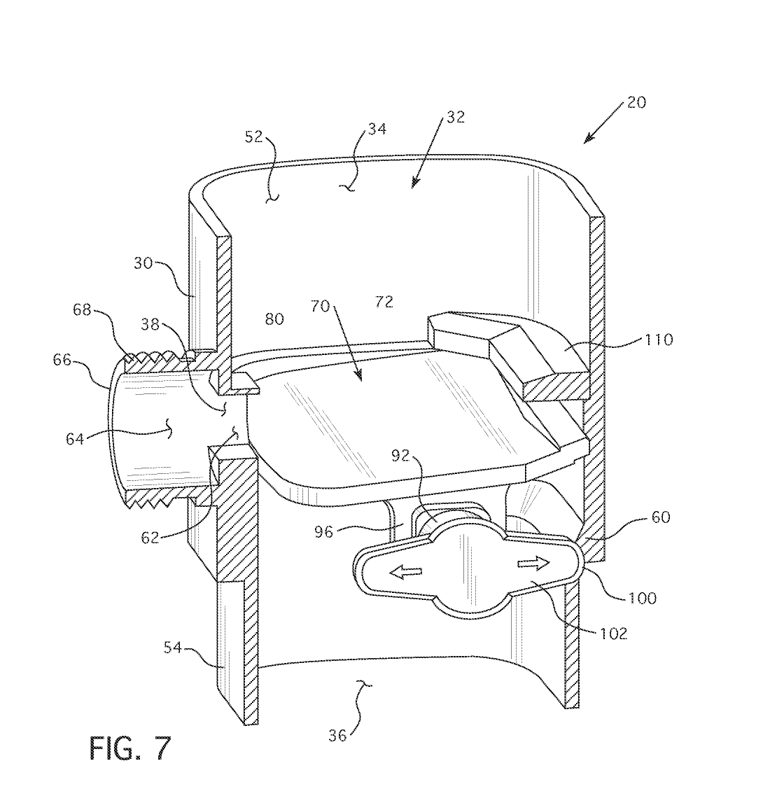

### DESCRIPTION OF THE PREFERRED EMBODIMENTS

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof.

As used herein, the statement that two or more parts or components “engage” one another shall mean that the elements exert a force or bias against one another either directly or through one or more intermediate elements or components.

As used herein, the word “unitary” means a component is created as a single piece or unit. That is, a component that includes pieces that are created separately and then coupled together as a unit is not a “unitary” component or body.

As used herein, the term “number” shall mean one or an integer greater than one (i.e., a plurality).

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coup component is a nut.

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, “correspond,” when used in conjunction with a description of an element's shape or size, indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are said to fit “snugly” together or “snuggly correspond.” In that situation, the difference between the size of the components is even smaller whereby the amount of friction increases. If the element defining the opening and/or the component inserted into the opening are made from a deformable or compressible material, the opening may even be slightly smaller than the component being inserted into the opening. This definition is further modified if the two components are said to “substantially correspond,” “Substantially correspond” means that the size of the opening is very close to the size of the element inserted therein; that is, not so close as to cause substantial friction, as with a snug fit, but with more contact and friction than a “corresponding fit,” i.e., a “slightly larger” fit. In reference to contours, perimeters and similar constructs, “correspond” means the constructs have similar contours, perimeters, shapes, and/or characteristics.

As used herein, a “planar body” or “planar member” is a generally thin element including opposed, wide, generally flat surfaces as well as a thinner edge surface extending between the wide flat surfaces. The edge surface may include generally flat portions, e.g. as on a rectangular planar member, or be curved, as on a disk, or have any other shape.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies.

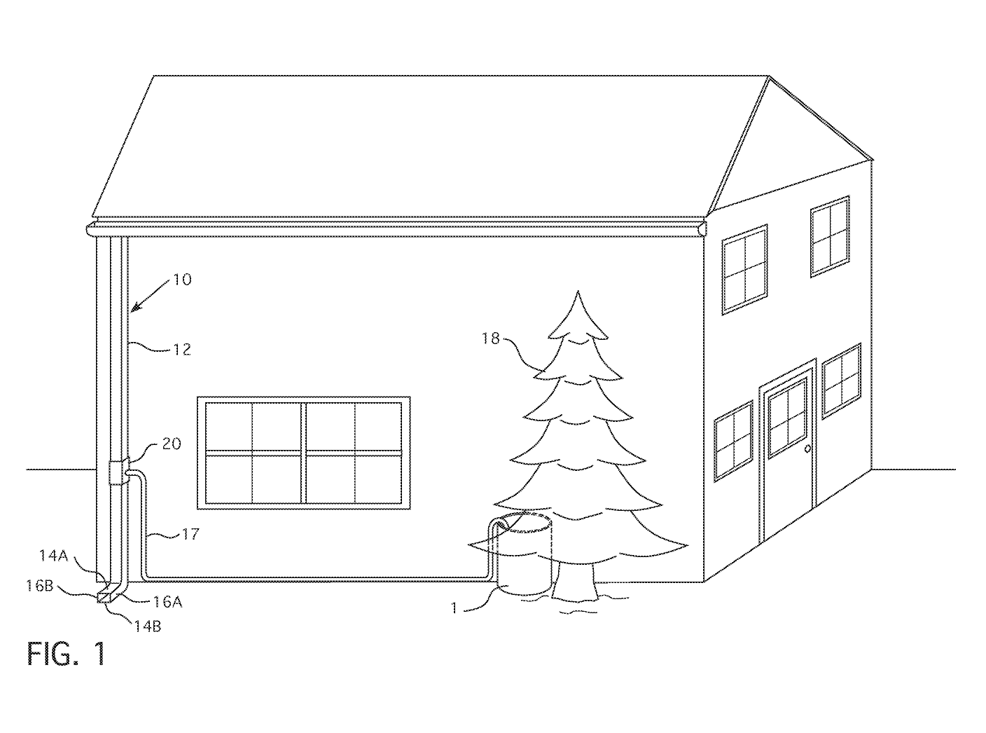

As shown in FIG. 1, a downspout 10 includes a tubular body 12 with an outer, first cross-sectional area and an inner, second cross-sectional area. In an exemplary embodiment, the downspout body 12 has a generally rectangular cross-sectional shape with two generally parallel longitudinal sides 14A, 14B and two generally parallel lateral sides 16A, 16B. The downspout body 12 is structured to be coupled to, and in fluid communication with a gutter, not shown, as is known. That is, a gutter extends generally horizontally about a structure or a portion of a structure. The downspout body 12 extends generally vertically from an upper elevation adjacent the gutter to a lower elevation adjacent the ground or other drain. It is understood that, during a rain shower, rainwater, along with debris, flows through the gutter and into the downspout 10. The downspout 10 includes an outlet, not shown, that is generally the same cross-sectional area as the downspout body 12. In this configuration, debris that passes through the downspout 10 is less likely to become stuck with the downspout 10. In an exemplary embodiment, the downspout body 12 is made of a generally thin material such as, but not limited to, sheet metal or vinyl.

The downspout body 12 is, in an exemplary embodiment, “spaced” from a concealing construct 18. As used herein “spaced” means by a distance of at least 50 feet. As shown in the figures, the concealing construct 18 is represented as shrubbery but, as used herein, a “concealing construct” may be any type of construct capable of generally obscuring the visibility of a rain barrel 1 or a similar liquid storage device. The downspout body 12 is coupled to, and in fluid communication with, a rain barrel 1 by a common garden hose 17, i.e. a garden hose with a coupling having standard hose threads, via a diverter assembly 20. As used herein, “standard hose threads” are threads structured to correspond to the threads on a common garden hose. Moreover, because a common garden hose 17 typically has an extended length, i.e. a length of over 50 feet, the rain barrel 1 can be position behind the concealing construct 18. That is, the rain barrel 1 is spaced from the downspout 10.

The diverter assembly 20 is structured to be installed on the downspout 10. The diverter assembly 20 is further structured to selectively direct rainwater in the downspout 10, or a portion thereof, to one of a number of outlet ports 36, 38. That is, the diverter assembly 20 includes a housing assembly 30 and a deflector assembly 70. Generally, the housing assembly 30 defines a generally vertical passage 32 and includes an inlet port 34, a first outlet port 36 and a second outlet port 38. The deflector assembly 70 includes a movable deflector member 72 that is movably disposed in housing assembly passage 32. The deflector member 72 is structured to, and does, move between a number of positions including a first position, wherein a substantial portion of the rainwater is directed to the first outlet port 36, a dumping position wherein debris collected on the deflector member 72 falls through the first outlet port 36, and a second position wherein a substantial portion of the rainwater is directed to the second outlet port 38.

The housing assembly 30, in an exemplary embodiment, includes a unitary, tubular body 40 that defines the passage 32 as well as inlet port 34, first outlet port 36 and second outlet port 38. The housing assembly body 40 has a cross-sectional shape that generally corresponds with the cross-sectional shape of the downspout body 12. Thus, in an exemplary embodiment, the housing assembly body 40 has a number of sidewalk 41 disposed as a generally rectangular cross-sectional shape with two generally parallel longitudinal sides 42A, 42B (identified below as first and second longitudinal sides 42A, 42B) and two generally parallel lateral sides 44A, 44B. The housing assembly body 40 includes an upper, first portion 46, a medial, second portion 48, and a lower, third portion 50. The housing assembly body first portion 46 includes an open, upper end 52 that defines the inlet port 34. The housing assembly body third portion 50 includes an open, lower end 54 that defines the first outlet port 36. At a location between the inlet port 34 and the outlet port 36, the housing assembly body 40 defines the second outlet port 38. Further, in an exemplary embodiment, the housing assembly body 40 defines two opposed openings 39 that are part of the rotatable coupling assembly 74, described below.

In an exemplary embodiment, the housing assembly body first portion 46 has an outer, third cross-sectional area and an inner, fourth cross-sectional area. The housing assembly body second portion 48 has an outer, fifth cross-sectional area and an inner, sixth cross-sectional area. The housing assembly body third portion 50 has an outer, seventh cross-sectional area and an inner, eighth cross-sectional area.

In an exemplary embodiment, the thickness of housing assembly body 40 along each longitudinal side 42A, 42B and each lateral side 44A, 44B is generally constant in the housing assembly body first portion 46. Further, the housing assembly body first portion 46 is structured to extend about the downspout body 12. That is, the fourth cross-sectional area is larger than the first cross-sectional area. In an exemplary embodiment, the fourth cross-sectional area corresponds to, or snuggly corresponds to, the first cross-sectional area. Thus, the downspout body 12 fits within the inlet port 34. Stated alternatively, the inlet port 34 is sized to extend about and substantially correspond to the first cross-sectional area.

Further, in an exemplary embodiment, the sixth cross-sectional area is smaller than the fourth cross-sectional area. In this configuration, there is an inwardly extending first flange 56 between the housing assembly body first portion 46 and the housing assembly body second portion 48. In an exemplary embodiment, the sixth cross-sectional area is smaller than the fourth cross-sectional area by an amount generally corresponding to the first cross-sectional area. Stated alternately, the first cross-sectional area and the sixth cross-sectional area are generally the same. In this configuration, the first flange 56 is structured to act as an abutment surface, as described below. Further, in an exemplary embodiment, the third cross-sectional area and the fifth cross-sectional area are substantially the same or the same. In this configuration, the outer surface of the housing assembly body 40 is generally smooth over the first and second portions 36, 38.

The seventh cross-sectional area, in an exemplary embodiment, is smaller than the fifth cross-sectional area. In this configuration, there is an outer, second flange 58 at the interface of the housing assembly body second portion 48 and the housing assembly body third portion 50. The second flange 58 is also structured to act as an abutment surface, as described below. The seventh cross-sectional area is smaller than the second cross-sectional area. In an exemplary embodiment, the seventh cross-sectional area corresponds to, or snuggly corresponds to, the second cross-sectional area. Thus, the housing assembly body third portion 50 is structured to fit within the downspout body 12. Stated alternatively, the first outlet port 36 is sized to be disposed within and substantially correspond to the second cross-sectional area.

Further, in an exemplary embodiment, the eighth cross-sectional area is smaller than the sixth cross-sectional area. So as to reduce the number of internal flanges, which may collect debris, the reduction in the cross-sectional area between the sixth cross-sectional area and the eighth cross-sectional area is, in an exemplary embodiment, accomplished by a tapered fillet 60 disposed, substantially, opposite the second outlet port 38 and at the lower end of the housing assembly body second portion 48. As shown, the tapered fillet 60 is disposed along the housing assembly body first longitudinal side 42A. Further, the tapered fillet 60 extends slightly over the housing assembly body two lateral sides 44A, 44B adjacent the first longitudinal side 42A. The tapered fillet 60 is narrow at the upper end and wider at the bottom end. Other than at the tapered fillet 60, the inner surface of the housing assembly body third portion 50 is generally aligned with, i.e. there is a substantially smooth transition between, the housing assembly body second portion 48.

The housing assembly body 40 further defines the second outlet port 38. In an exemplary embodiment, the second outlet port 38 is a generally horizontally extending passage disposed on one side of the housing assembly body 40. As shown in the Figures, the second outlet port 38 is disposed on, and through, the second longitudinal side 42B. In an exemplary embodiment, the second outlet port 38 includes an inner, first portion 62 and an outer, second portion 64. The second outlet port first portion 62 passes through the housing assembly body second longitudinal side 42B. The second outlet port first portion 62 has a generally rectangular cross-section. In an exemplary embodiment, the second outlet port first portion 62 has a cross-sectional area of between about 0.25 in.² and 0.50 in.², or about 0.375 in.². As used herein, a port having a cross-sectional area of between about 0.24 in.² and 0.45 in.² or about 0.34 in.² is a “debris restricting port.” In any claim that recites the cross-sectional area of a debris restricting port, the limited cross-sectional area of a debris restricting port is an important feature. The second outlet port second portion 64 has a generally circular cross-section. The second outlet port second portion 64 extends outwardly from the housing assembly body second longitudinal side 42B. That is, the second outlet port 38 includes a generally cylindrical collar 66. In an exemplary embodiment, the collar has a generally smooth inner surface and a threaded outer surface 68. The collar threaded outer surface 68 has standard hose threads. As used herein, “standard hose threads” are threads structured to correspond to the threads on a common garden hose.

In an exemplary embodiment, deflector assembly 70 includes a generally planar deflector member 72 and a rotatable coupling assembly 74. In an exemplary embodiment, the deflector member 72 has a cross-sectional area generally corresponding to the sixth cross-sectional area. Further, the deflector member 72 is rotatably coupled to the housing assembly within the housing assembly body second portion 48. As noted above, the deflector member 72 is structured to, and does, move between a number of positions including a first position, wherein a substantial portion of the rainwater is directed to the first outlet port 36, a dumping position wherein debris collected on the deflector member 72 falls through the first outlet port 36, and a second position wherein a substantial portion of the rainwater is directed to the second outlet port 38.

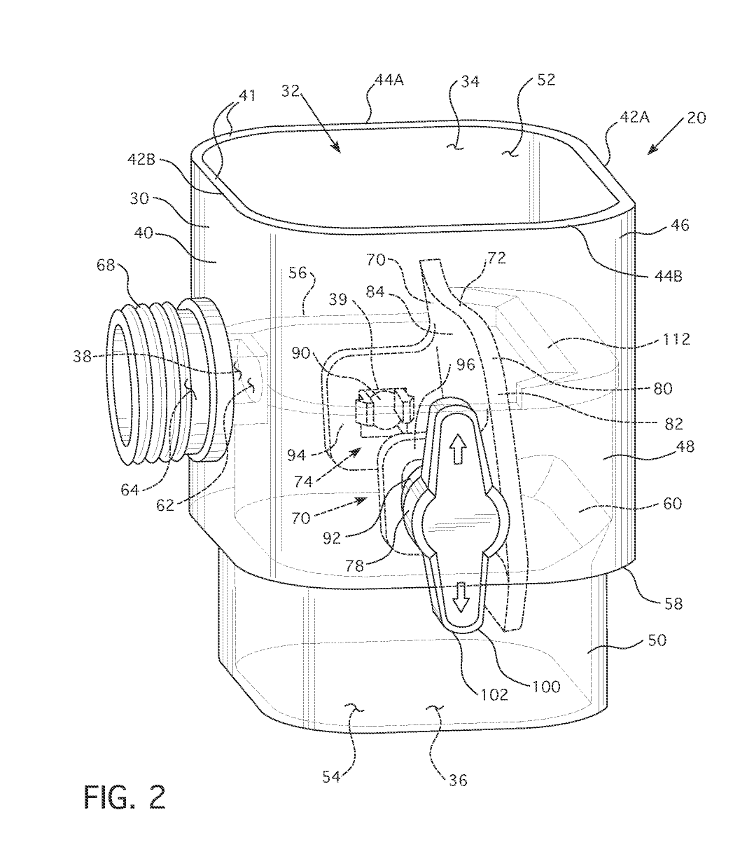

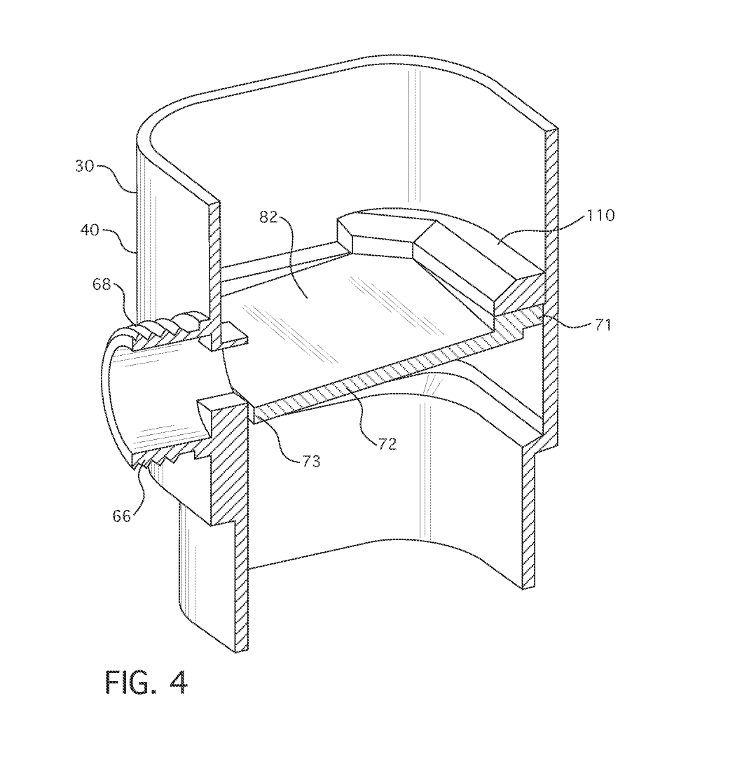

In an exemplary embodiment, the deflector member 72 includes an elongated, generally planar body 80 with an upper, first side 82 (FIG. 4), a lower, second side 84 (FIG. 2). In an exemplary embodiment, the deflector member body first side 82 is concave. The concavity extends in a direction generally perpendicular to the deflector member 72 axis of rotation, discussed below. In an exemplary embodiment, the deflector member body 80 has a cross-sectional area generally corresponding to the sixth cross-sectional area. It is noted that the deflector member 72 is not required to seal the housing assembly passage 32 and, in an exemplary embodiment, the deflector member body 80 loosely corresponds to the sixth cross-sectional area.

In an exemplary embodiment, the rotatable coupling assembly 74 includes two axles 76, 78 disposed on opposite sides of the deflector member body 80, as well as the opposed openings 39 discussed above. As shown, the axles 76, 78 are generally cylindrical bodies 90, 92 with generally circular outer surfaces. The axle bodies 90, 92 axes are substantially aligned and define an axis of rotation for the rotatable coupling assembly 74. In an exemplary embodiment, as shown, the rotatable coupling assembly 74 includes offset tabs 94, 96 disposed between, and coupled, directly coupled or fixed, to the axle bodies 90, 92.

The rotatable coupling assembly 74, and therefore the deflector assembly 70 includes an actuator 100. The actuator 100 includes an elongated body 102. The actuator body 102 is coupled, directly coupled or fixed to one of the axle bodies 90, 92. Movement of the actuator body 102 is imparted to the associated axle body 90 (as shown) as well as to the deflector member body 80.

In an exemplary embodiment, the deflector assembly 70 includes a stop plate 110. The stop plate 110 is disposed within the passage 32 and extends along the housing assembly body first longitudinal side 42A. Further, the stop plate 110 extends slightly over the housing assembly body two lateral sides 44A, 44B adjacent the first longitudinal side 42A. The stop plate 110 is structured to stop the rotation of the deflector member body 80. The stop plate 110 includes an upper side 112 that, in an exemplary embodiment, is angled generally downwardly.

The diverter assembly 20 is assembled as follows. The deflector assembly 70 is rotatably coupled to the housing assembly 30. That is, the deflector member 72 is fixed, or unitary with, the offset tabs 94, 96. The deflector member 72 and offset tabs 94, 96 are moved into the passage 32 and the offset tabs 94, 96 are coupled, directly coupled, or fixed to the axle bodies 90, 92. The axle bodies 90, 92 are rotatably disposed in the housing assembly opposed openings 39. The deflector member 72 is positioned adjacent the second outlet port first portion 62 and the stop plate 110 as described below. The actuator 100 is fixed to an axle body 90, 92. In an exemplary embodiment, the longitudinal axis of the actuator 100 generally corresponds, i.e. is parallel to, the plane of the deflector member 72. Further, the concavity extends in a direction generally perpendicular to the deflector member 72 axis of rotation as defined by the axis of rotation of the axle bodies 90, 92.

The diverter assembly 20 is coupled to a downspout 10 as follows. A break is made in the downspout body 12 approximately the same height as the diverter assembly 20. This divides the downspout body 12 into an upper portion 11 and a lower portion 13. The lower end of the downspout body upper portion 11 is disposed in inlet port 34. That is, as noted above, inlet port 34 is defined by the housing assembly body first portion 46 which, in an exemplary embodiment, a fourth cross-sectional area that corresponds to, or snuggly corresponds to, the first cross-sectional area of the downspout body 12. Further, housing assembly body third portion 50, which defines the first outlet port 36, is disposed in the upper end of the downspout body lower portion 13. That is, housing assembly body third portion 50 has an outer, seventh cross-sectional area that is smaller than the second cross-sectional area, i.e. the inner cross-sectional area of the downspout body 12. Thus, the housing assembly body third portion 50 is structured to be, and is, inserted into the upper end of the downspout body lower portion 13. Further, when the housing assembly body third portion 50 is inserted into the upper end of the downspout body lower portion 13, the downspout body lower portion 13 abuts the second flange 58. In this configuration, water and debris that passes through the downspout 10 also passes through the diverter assembly 20. As noted above, the deflector member 72 is structured to, and does, move between a number of positions including a first position, wherein a substantial portion of the rainwater is directed to the first outlet port 36, a dumping position wherein debris collected on the deflector member 72 falls through the first outlet port 36, and a second position wherein a substantial portion attic rainwater is directed to the second outlet port 38. In an exemplary embodiment, when the deflector member 72 is in the first position, the deflector member 72 minimally fills said housing assembly passage 34. As used herein and when discussing a generally planar member disposed in a passage, to “minimally fill” a passage means that the plane of the generally planar member is disposed generally parallel to the longitudinal axis of the passage. That is, the deflector member 72 is disposed so that the plane of the deflector member 72 extends generally vertically. In this position, water and debris passes through the housing assembly passage 32 generally unimpeded. That is, the cross-sectional area of the housing assembly passage 32 is sufficiently large so as to allow debris to pass the deflector assembly 70. Thus, water and debris pass from the inlet port 34 to, and through, the first outlet port 36.

When the deflector member 72 is in the second position, the plane of the deflector member 72 extends generally horizontally. In this orientation, the deflector member 72 substantially fills said housing assembly passage 32. It is noted that the rotation of the deflector member 72 (or deflector member body 80) is arrested by the deflector member 72 abutting the first flange 56. In an exemplary embodiment, the deflector member 72 (or deflector member body 80) in the second position is slightly angled and has an upper end 71 and a lower end 73. The deflector member upper end 71 contacts the stop plate 110. The deflector member lower end 73 is disposed adjacent to the second outlet port first portion 62. Thus, in this position, a substantial portion of any rainwater in the diverter assembly 20 contacts the deflector member 72, is directed toward the center of the deflector member 72 due to the concavity, and then to the deflector member lower end 73. The rainwater then exits the diverter assembly 20 via second outlet port 38. Further, large debris, such as but not limited leaves and twigs, are too large to pass through the debris restricting second outlet port 38. Thus, debris collects on the deflector member body first side 82.

When the deflector member 72 is in the dumping position the plane of the deflector member 72 is steep relative to a horizontal plane and the deflector member 72 partially fills the housing assembly passage 32. As used herein, “steep” means an angle of at least 50 degrees. In this position, debris that has collected on the deflector member body first side 82 slides off the deflector member 72 and exits the housing assembly 30 via the second outlet port 38. It is noted that, when the deflector member 72 is in the dumping position, the removal of debris occurs whether it is raining or not, however, some rainwater flow generally assists in the removal of the debris.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A diverter assembly for a downspout, said downspout including a tubular body with an outer, first cross-sectional area and an inner, second cross-sectional area, said diverter assembly comprising:
a housing assembly defining a generally vertical passage and including an inlet port, a first outlet port and a second outlet port;
a deflector assembly including a movable defector member, said deflector member disposed in said housing assembly passage; and
wherein said deflector member moves between a first position, dumping position, and a closed position.

2. The diverter assembly of claim 1 wherein:
when said deflector member is in said first position, said deflector member minimally fills said housing assembly passage;
when said deflector member is in said dumping position, said deflector member partially fills said housing assembly passage; and
when said deflector member is in said second position, said deflector member substantially fills said housing assembly passage.

3. The diverter assembly of claim 2 wherein:
said inlet port is sized to extend about and substantially correspond to said first cross-sectional area; and
said first outlet port is sized to be disposed within and substantially correspond to said second cross-sectional area.

4. The diverter assembly of claim 2 wherein said second outlet port is sized to be a debris restricting port.

5. The diverter assembly of claim 2 wherein:
said deflector member includes an elongated, generally planar body with an upper, first side, a lower, second side, and an upper end;
said deflector member rotatably coupled to said housing assembly and having an axis of rotation;
said inlet port is disposed substantially vertically above said deflector member;
said first outlet port is disposed substantially vertically below said deflector member; and
wherein, when said deflector member is in said dumping position, said deflector member body is disposed at a steep angle relative to a generally horizontal line.

6. The diverter assembly of claim 5 wherein said deflector member body includes a concavity on said first side, said concavity extending generally perpendicular to said deflector member axis of rotation.

7. The diverter assembly of claim 5 wherein:
said housing assembly includes a number of planar sidewalk defining a generally rectangular cross-sectional shape and including a first longitudinal sidewall, a second longitudinal sidewall, a first lateral sidewall and a second lateral sidewall;
said deflector assembly includes a stop plate extending into said housing assembly passage; and
wherein, when said deflector member is in said second position, said deflector member body upper end abuts said stop plate.

8. The diverter assembly of claim 5 wherein:
said deflector assembly includes an actuator;
said deflector assembly actuator including an elongated body;
said deflector assembly actuator body rotatably coupled to said housing assembly; and
said deflector assembly actuator body fixed to said deflector member body such that the longitudinal axis of said deflector assembly actuator body is generally parallel to the deflector member body.

9. The diverter assembly of claim 1 wherein:
said housing assembly includes a tubular body having an upper, first portion, a medial, second portion, and a lower, third portion;
wherein said housing assembly body first portion has an outer, third cross-sectional area and an inner, fourth cross-sectional area;
wherein said housing assembly body second portion has an outer, fifth cross-sectional area and an inner, sixth cross-sectional area;
wherein said housing assembly body third portion has an outer, seventh cross-sectional area and an inner, eighth cross-sectional area;
wherein said housing assembly body first portion is structured to extend about said downspout and wherein said fourth cross-sectional area corresponds to said first cross-sectional area; and
wherein said housing assembly body third portion is structured to fit within said downspout body and said seventh cross-sectional area corresponds to said second cross-sectional area.

10. The diverter assembly of claim 1 wherein:
said deflector member includes an elongated, generally planar body with an upper, first side, a lower, second side, and an upper end;
said deflector member rotatably coupled to said housing assembly and having an axis of rotation;
said inlet port is disposed substantially vertically above said deflector member;
said first outlet port is disposed substantially vertically below said deflector member; and
wherein, when said deflector member is in said dumping position, said deflector member body is disposed at a steep angle relative to a generally horizontal line.

11. A downspout comprising:
a tubular body with an outer, first cross-sectional area and an inner, second cross-sectional area;
a diverter assembly including a housing assembly and a deflector assembly;
said housing assembly defining a generally vertical passage and including an inlet port, a first outlet port and a second outlet port;
said deflector assembly including a movable deflector member, said deflector member disposed in said housing assembly passage; and
wherein said deflector member moves between a first position, a dumping position, and a closed position.

12. The downspout of claim 11 wherein:
when said deflector member is in said first position, said deflector member minimally fills said housing assembly passage;
when said deflector member is in said dumping position, said deflector member partially fills said housing assembly passage; and
when said deflector member is in said second position, said deflector member substantially fills said housing assembly passage.

13. The downspout of claim 12 wherein:
said inlet port is sized to extend about and substantially correspond to said first cross-sectional area; and
said first outlet port is sized to be disposed within and substantially correspond to said second cross-sectional area.

14. The downspout of claim 12 wherein said second outlet port is sized to be a debris restricting port.

15. The downspout of claim 12 wherein:
said deflector member includes an elongated, generally planar body with an upper, first side, a lower, second side, and an upper end;
said deflector member rotatably coupled to said housing assembly and having an axis of rotation;
said inlet port is disposed substantially vertically above said deflector member;
said first outlet port is disposed substantially vertically below said deflector member; and
wherein, when said deflector member is in said dumping position, said deflector member body is disposed at a steep angle relative to a generally horizontal line.

16. The downspout of claim 15 wherein said deflector member body includes a concavity on said first side, said concavity extending generally perpendicular to said deflector member axis of rotation.

17. The downspout of claim 15 wherein:
said housing assembly includes a number of planar sidewalls defining a generally rectangular cross-sectional shape and including a first longitudinal sidewall, a second longitudinal sidewall, a first lateral sidewall and a second lateral sidewall;
said deflector assembly includes a stop plate extending into said housing assembly passage; and
wherein, when said deflector member is in said second position, said deflector member body upper end abuts said stop plate.

18. The downspout of claim 15 wherein:
said deflector assembly includes an actuator;
said deflector assembly actuator including an elongated body;
said deflector assembly actuator body rotatably coupled to said housing assembly; and
said deflector assembly actuator body fixed to said deflector member body such that the longitudinal axis of said deflector assembly actuator body is generally parallel to the deflector member body.

19. The downspout of claim 11 wherein:
said housing assembly includes a tubular body having an upper, first portion, a medial, second portion, and a lower, third portion;
wherein said housing assembly body first portion has an outer, third cross-sectional area and an inner, fourth cross-sectional area;
wherein said housing assembly body second portion has an outer, fifth cross-sectional area and an inner, sixth cross-sectional area;
wherein said housing assembly body third portion has an outer, seventh cross-sectional area and an inner, eighth cross-sectional area;
wherein said housing assembly body first portion is structured to extend about said downspout and wherein said fourth cross-sectional area corresponds to said first cross-sectional area; and
wherein said housing assembly body third portion is structured to fit within said downspout body and said seventh cross-sectional area corresponds to said second cross-sectional area.

20. The downspout of claim 11 wherein:
said deflector member includes an elongated, generally planar body with an upper, first side, a lower, second side, and an upper end;
said deflector member rotatably coupled to said housing assembly and having an axis of rotation;
said inlet port is disposed substantially vertically above said deflector member;
said first outlet port is disposed substantially vertically below said deflector member; and
wherein, when said deflector member is in said dumping position, said deflector member body is disposed at a steep angle relative to a generally horizontal line.
